(19) United States
(12) Patent Application Publication
(10) Pub. No.: US 2015/0368965 A1
(43) Pub. Date: Dec. 24, 2015

(54) TRANSPARENT ROLLER SHUTTER

(71) Applicants: Guy MEYERE, Marseille (FR); Nadège MEYERE, Marseille (FR)

(72) Inventors: Guy MEYERE, Marseille (FR); Nadège MEYERE, Marseille (FR)

(21) Appl. No.: 14/412,583

(22) PCT Filed: Jul. 3, 2013
(86) PCT No.: PCT/FR2013/051568

§ 371 Date: Jan. 2, 2015

(30) Foreign Application Priority Data
Jul. 4, 2012 (FR) 1256423

(51) Int. Cl. E06B 9/58; E06B 9/15

(52) U.S. Cl. CPC E06B 9/58; E06B 9/15; E06B 2009/1572; E06B 2009/1566; E06B 2009/1527

(57) ABSTRACT

A transparent roller shutter having an apron that can be wound about a horizontal shaft or drum positioned above said apron, the shutter having a plurality of transparent horizontal slats hinged together by hinge devices, the opposing vertical edges of the hinged apron moving in lateral guides or slides, wherein each of the slats has a transverse profile curved in shape of which the concavity faces towards the shaft or winding drum when the apron is wound onto the shaft or drum, and wherein each slat of the plurality of horizontal slats consists of two or more than two modules or portions of slats that are abutting and are assembled by engagement of the ends of same.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention concerns a rollup curtain, in particular a transparent rollup curtain. More precisely, it concerns a rollup curtain of the type featuring an apron composed of horizontal slats articulated between themselves and which rolls up on a horizontal shaft or drum placed above, the edges of this articulated apron moving within lateral guides or slides.

2. Description of Related Art Including Information Disclosed Under 37 CFR 1.97 and 37 CFR 1.98

Such rollup curtains are generally relied upon to be shaped and fitted to constitute rollup shutters or analog closures, or dividing partitions, or wall portions, or complete partitions of certain locations.

Such curtains permit the view and the passage of light from the inside to the outside and/or from the outside to the inside, and this even when the transparent rollup curtain is in the lowered position.

This type of transparent rolling curtain may be applied:
for creating secure closures of ingress to certain locales such as garages, stores . . . ; in this application, such rolling curtains allow passers-by to see the merchandise displayed, even when the curtain is lowered, while ensuring security, preventing theft and vandalism;
for the installation of retractable transparent partitions permitting the transformation of certain covered spaces such as decks of individual houses, pool houses, swimming pool shelters, outdoor spaces of diverse commercial businesses, cafés, restaurants . . . , into winter gardens, game or reception areas, allowing these spaces to be occupied during the cold season or in any atmospheric conditions;
for the erection of retractable partitions in certain work places such as workshops, offices, reception desks in hotels or hospitals;
for the creation of retractable partitions in areas constituting chemical, thermal, acoustical or biological hazards (laboratories, nuclear power plants . . . ) or in places of high foot traffic (airports, railway stations . . . );
for the installation of retractable partitions in residential housing or other locales situated in zones exposed to cyclones and/or hurricanes while permitting to close and secure the openings without obstructing the view.

Document FR-2.945.313 describes a transparent security curtain composed of a number of horizontal transparent slats, interconnected in an articulated manner. Each flat slat consists of a plurality of modules abutting each other. It is furthermore connected, in an articulated manner, to the slat immediately above or below it through two different complementary joint sections on the neighboring edges of two adjacent slats and interlocked one in the other. Finally, a divisible blocking piece is positioned at the end of each plate to stabilize the system.

The transparent security curtain described in document FR-2.945.313 has notably these disadvantages:
a noisy operation during the lowering and raising movements;
the need for two different joint sections to create the articulated link of the slats increases production costs and makes installation more difficult;—the flat slats it consists of result in an irregular roll-up of the apron and a significant volume and thereby in a very bulky casing for housing the rolled up curtain;
the slats consists of butt-jointed modules and are assembled to each other through superposition of their ends which creates a large number of opaque, unattractive areas and which reduce visibility.

Document FR-2.941.989 describes a slat for roll-up shutters comprising a solid core, constituted of a transparent or translucent material, covered over a portion of each of its two sides by a coating consisting of an opaque material, this coating being applied on the back side and the front side of said core so that an incident ray of light cannot go through said slat without being stopped by at least one of the two coatings. Said slat presents an overall curved transversal section without any precision being applied to the desirability of this disposition.

According to an implementation of the invention described in this document, the slat for roll-up shutters has a curved outer surface and according to a preferred implementation the two surfaces of the core are concave. It is possible to vary the shape of the slat and notably the shape of the core, depending on the amount of light that the expert wants to see transmitted through said slat. This is the only function devolved to this shape.

Document FR-2.643.938, describes a transparent security roll-up shutter consisting of a number of horizontal slats articulated among themselves through hinges.

According to one implementation the apron of this roll-up shutter may be coiled around a drum. In this case the coiling obtained is also irregular and requires a very bulky casing for housing the coiled curtain. Furthermore, the linkage means of the interconnected slats seriously complicate the replacement of any one of them, should that ever become necessary.

Document EP-0.354.987 describes a transparent coiled shutter consisting of distinct coiled shutter slats, interconnected with tensile strength, made of transparent plastic, that can be coiled around a coil shaft and which can be linked together with the interposition of arched coupling sections, the latter being equipped on their longitudinal edges with receiving grooves for the stop heads presented by the horizontal edges of the slats of the coiled shutter. Said heads can be introduced into the receiving grooves of the coupling profiles and be maintained there with the possibility of swiveling.

The major disadvantage of this shutter is the complexity of its design, because it implies the utilization of several slats of different height which then need to be assembled in a strict sequence to obtain a coil of polygonal shape.

Document WO-2009/035701 describes a transparent coiled shutter consisting of flat slats of decreasing height from the top to the bottom. This coiled shutter presents thus the same disadvantage as the device disclosed in document EP-0.354.987.

Document GB-2.120.306 describes a coiled protective grating formed by a series of transparent slats produced all in one piece and extending horizontally and by metallic rods interconnected in a pivoting manner by means of preferably circular ribs extending along the upper and lower edge of each slat, which are received inside the bushings formed in the metal of the rods.

The main disadvantage of the slats produced all in one piece is that they are not very shock-resistant, making the transparent curtain very fragile. Furthermore the process of manufacturing, transporting and installing such slats which generally present significant lengths (in the order of 2 to 7 meters) is complex and costly.

It is also customary, especially when the articulated slats forming the apron of the coiled curtains are of relatively great length, to produce each of these slats in two or more than two modules or parts of abutting slats.

For example, document EP-0.445.064 describes a security grille featuring several parallel rows of sections; between each section is located a number of elements made of a transparent plastic material, preferably of polycarbonate, these elements being separated by intermediary stiffening elements made for example of aluminum. In this implementation of the grille featuring a plurality of polycarbonate elements, the stiffening elements are of aluminum, so they are opaque which changes the transparency of the grille, particularly in the implementation where the aluminum elements have the same dimension as the polycarbonate elements.

To remedy this problem of lack of transparency due to the presence of opaque stiffeners, a second implementation is proposed in which the transparent elements present the same length as the parallel sections. Now, as already explained for the GB-2.120.306 document, this implementation in which the transparent modules are made of a single piece, is only mildly shock-resistant, making the transparent curtain very fragile.

Document FR-2.955.885 describes a coiled shutter element consisting of an assembly of rows of modules where each module is overall of a rectangular shape and the large sides are parallel to the coiling axle of said shutter and where the modules of a same row are interconnected by way of a bar or tube of circular section passing through hinges with which the large sides are equipped.

According to this document two adjacent modules are joined at their small sides and one of the small sides of a module is provided with a lip that overlaps the small side of the adjacent module.

A product of this kind is also described in document FR-2.945.313, according to which the abutting ends of the parts of slats or modules are assembled through simple overlapping or are assembled by bracketing.

According to such an abutting mode, the ends assembled through simple overlapping or by bracketing are complex and not very compatible with a transparent curtain because they create areas of excessive thickness and non-transparent vertical zones preventing perfect visibility and forming unsightly darkened surfaces and which have, furthermore, the disadvantage of not offering complete imperviousness to air, water, heat and cold.

Document U.S. Pat. No. 6,263,943 describes a modular coiled shutter for store doors and windows, composed of a plurality of rows of slats. Each slat is connected by means of loops to a lower slat and to an upper slat, allowing for limited movement of the slats and loops so that the modular coiled shutter can be rolled up and let down. Each slat can consist of a plurality of thin strips with reinforced ends. In order to connect the adjacent strips, each reinforced piece is provided with a coupler, the adjacent couplers presenting complementary coupling shapes enabling the interconnection of two adjacent strips.

However, these reinforced parts create areas of excessive thickness and vertical non-transparent zones preventing perfect visibility and creating unsightly darkened surfaces. Furthermore, the proposed couplers allowing rigid locking of the strips are complex, as they are for instance dovetailed, or have cylindrical recesses suitable for working together with an insert, thereby making manufacturing and installation complex and costly.

Also known are means of preventing the lateral dislocation of the slats in the grooves of the assembly and articulation sections, by means of plugs or stop caps of various designs, located at the ends of said sections. The systems using such stop caps are generally complex and awkward to handle.

It is the particular aim of the present invention to remedy the afore-mentioned disadvantages of prior art.

### BRIEF SUMMARY OF THE INVENTION

According to a first characteristic disposition, this aim has been achieved with a coiled curtain, in particular a transparent coiled curtain, of the kind featuring a roll-up apron comprising a number of horizontal slats articulated among themselves, by means of joint sections, said apron coiling up on an upper horizontal shaft or drum and its lateral edges are mounted with the ability of moving in vertical slides or guides, this transparent coiled curtain being especially remarkable in that each of said slats presents a transversal section of formed or curved shape, allowing the apron to be rolled up around the roll-up shaft or drum and assuming essentially the shape of said shaft or drum, the concavity of the slats being turned towards the roll-up shaft or drum when said apron is rolled up around the latter, and in that each slat of the plurality of horizontal slats consists of two or more than two modules or parts of slats abutted and assembled through fitting their ends together.

Thanks to this disposition it is possible to roll up the apron in a casing of reduced dimensions, the coiled shape thus obtained presenting a regular cylindrical shape.

For example, the invention makes it possible to roll up a coiled shutter of a height of more than 3 meters around an axis featuring a diameter of 133 mm, in a housing presenting a diameter of 300 mm.

According to one example of implementation, the abutting ends are provided with a groove and a rib respectively, extending over the entire height of said abutting ends of the modules, said groove being interlocked with said rib.

According to another example of implementation, the groove and the rib present a complementary triangular profile.

This kind of assemblage has the advantage of not creating any excessive thickness or alteration of visibility in the connecting zones and to ensure excellent imperviousness to air, water, heat and cold.

In a manner known as such, the slats are assembled to each other by means of joint and articulation sections the opposing longitudinal edges of which feature parallel grooves in which are engaged, for example by sliding, the opposite edges of said slats, and according to an advantageous implementation, these joint and articulation sections present a transversal curved profile the concavity of which is turned towards the coiling shaft or drum when said apron is rolled up around said shaft or drum.

According to an interesting implementation, the transparent coiled curtain is provided on its side with blocking caps in order to prevent any lateral sliding or pullout of the slats, and, according to a characteristic disposition of the invention, these blocking caps present a curved transversal profile the concavity of which is turned toward the coiling shaft or drum when said apron is rolled up on said shaft or drum.

According to a characteristic disposition of the invention, these blocking caps comprise a sealing body applied against the ends of the joint section, so as to close off the entrance of the articulation grooves made in said joint section. This body is fastened by at least one screw and preferably two screws penetrating into cavities made in the partition separating said grooves.

According to a preferred implementation, the internal face of said blocking ends presents excessive thickness which is engaged in the entrance of the articulation grooves of the joint sections, these thicker areas being shaped and dimensioned for being fitted into said entrances without any noticeable play.

The blocking caps according to the invention make it easier to keep the slats in position and to remove them if necessary which allows significant time savings.

According to another interesting characteristic disposition, the blocking caps present an upper fin or cap.

According to another characteristic disposition, the body of the blocking caps features, on its outside face, lateral, partly overlapping wings ensuring that the apron remain in the guiding slides thereby preventing any unhinging when faced with pullout forces, for example in case of violent winds generating such forces.

According to an advantageous implementation, the coiling curtain also features at least one ring, preferably a number of rings, to be positioned on the roll-up shaft and including a fin overreaching a portion of the ring and positioned away from the outer face of said ring, so that when the curtain goes up, the fins of the rings cover the first joint section in order to prevent the slats from rubbing on each other while the curtain is being rolled up and thus the deterioration of the latter through the appearance of unsightly scuff marks on the transparent slats affecting the visibility through the shutter and which would make said coiled shutter more fragile.

The device according to the invention offers several interesting advantages. Specifically:
the curved form of the slats permits the apron to coil around the shaft or drum presenting a regular, cylindrical shape so that it is possible to roll up the apron in a casing of reduced dimensions;
as the slats consist of a plurality of modules, they provide better resistance in comparison with a slat consisting of a single piece;
as the modules are assembled directly by fitting their ends together, without an opaque intermediary element, good transparency of the curtain is retained;
the ring positioned on the roll-up shaft and the upper ribs of the blocking pieces prevent the formation of scuff marks on the slats forming the roll-up shutter, thereby ensuring durability of the latter.

### BRIEF DESCRIPTION OF THE DRAWINGS

The aforementioned aims, characteristics and advantages, and still more, will become clearer in the following description and the attached drawings in which:

FIG. 1 is a front view of an example of implementation of the roll-up curtain to which the invention can be applied.

FIG. 2 is a partial front view at a larger scale than FIG. 1.

FIG. 3 is a partial, exploded front view of an example of implementation of the transparent roll-up curtain according to the invention.

FIG. 4 is a section view along line 4-4 of FIG. 1.

FIG. 5 is a side view of a transparent slat.

FIG. 6 is an analog view showing the articulated assembly of a slat positioned between an upper slat and a lower slat.

FIG. 7 is a front view illustrating a slat portion consisting of two abutted modules.

FIG. 8 is a section view at a larger scale along line 8-8 of FIG. 7.

FIG. 9 is a side view of a slat module.

FIG. 10 is a sectional view at a larger scale along line 10-10 of FIG. 9.

FIGS. 11 and 12 are detail views illustrating, at a larger scale, the details B and C respectively, of FIG. 10.

FIG. 13 is a view, at a larger scale, showing the abutment of two juxtaposed modules.

FIG. 14 is a partial perspective view of the joint and articulation sections.

FIG. 15 is a front view of one of the ends of this joint section.

FIG. 16 is a section view, at a larger scale, along line 16-16 of FIG. 15.

FIG. 17 is an enlarged side-face view of a soundproofing joint housed in the grooves of the joint sections.

FIG. 18 is a partial perspective view of a slat where the upper and lower edges are inserted in joint sections according to the invention.

FIG. 19 is a perspective view of a first example of implementation of a blocking end.

FIG. 20 is a perspective view of a second example of implementation of the blocking end.

FIG. 21 is a partial perspective view illustrating the sliding assembly of this second example of implementation of blocking ends in one of the guiding slides of the roll-up curtain.

FIG. 22 is an exploded perspective view of an example of implementation of the final slat of the roll-up curtain according to the invention.

FIGS. 23A, 23A′, 23B, 23B′ and 23C, 23 are exploded detail perspective views showing the fastening of the two implementation methods of the blocking end.

FIG. 24 is a perspective view of the roll-up ring according to the invention.

FIGS. 25A, 25B, 25C, 25D, and 25E are schematic views illustrating the assembly stages of the roll-up ring and the transparent roll-up shutter on the roll-up shaft.

FIG. 26 is a partially exploded perspective view of the roll-up shutter according to the invention.

FIG. 27 is a perspective view showing the roll-up shutter mounted on the roll-up shaft equipped with a number of roll-up rings.

FIG. 28 illustrates the start of the roll-up of the roll-up shutter.

FIG. 29 is a detail view of FIG. 28 showing the support action of the rib that the ring is equipped with.

FIG. 30 is a cross section view showing the transparent curtain according to the invention while it is being rolled up.

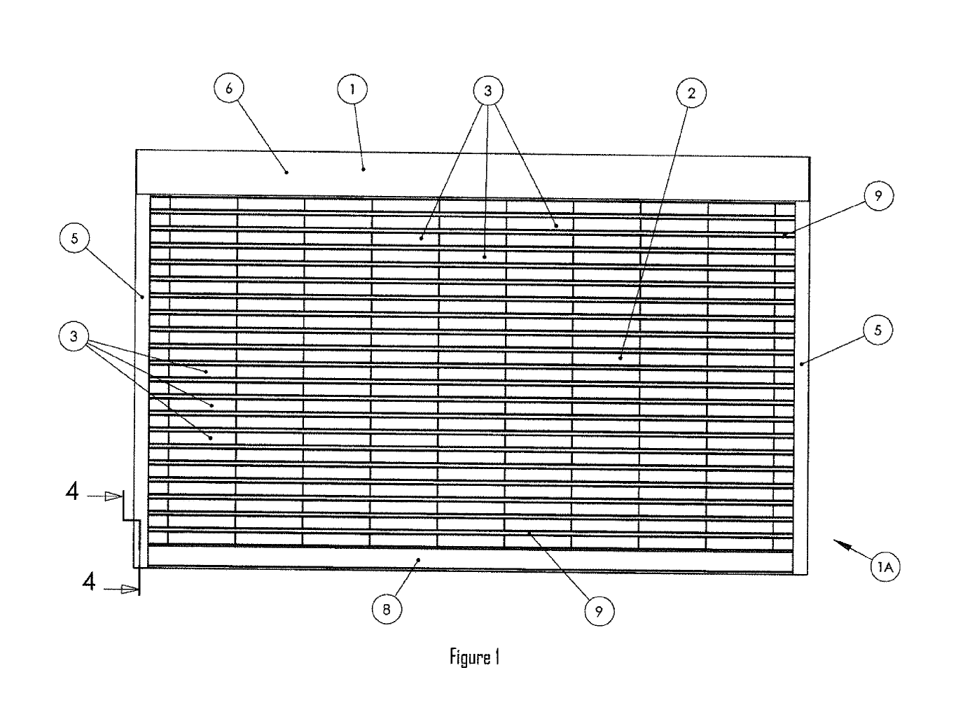

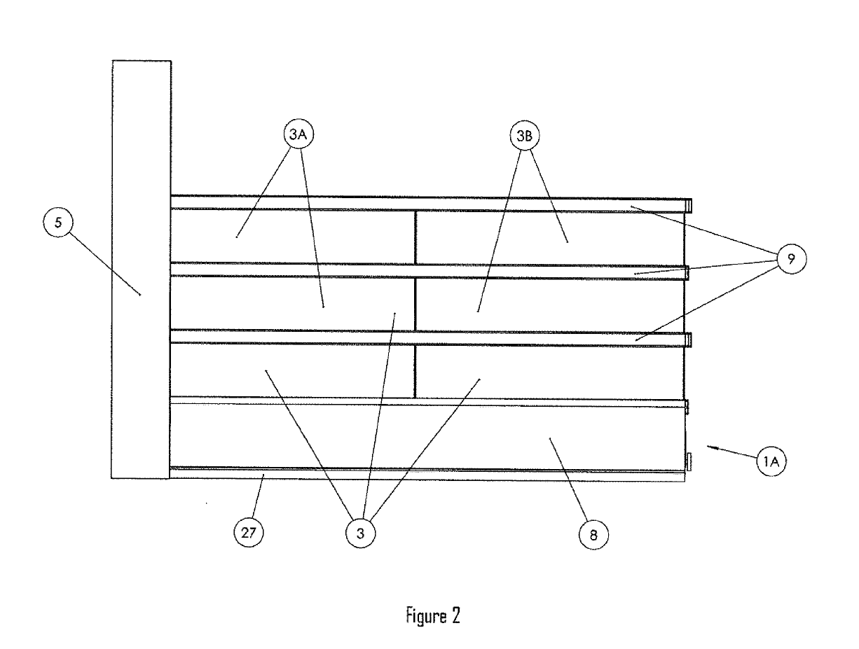

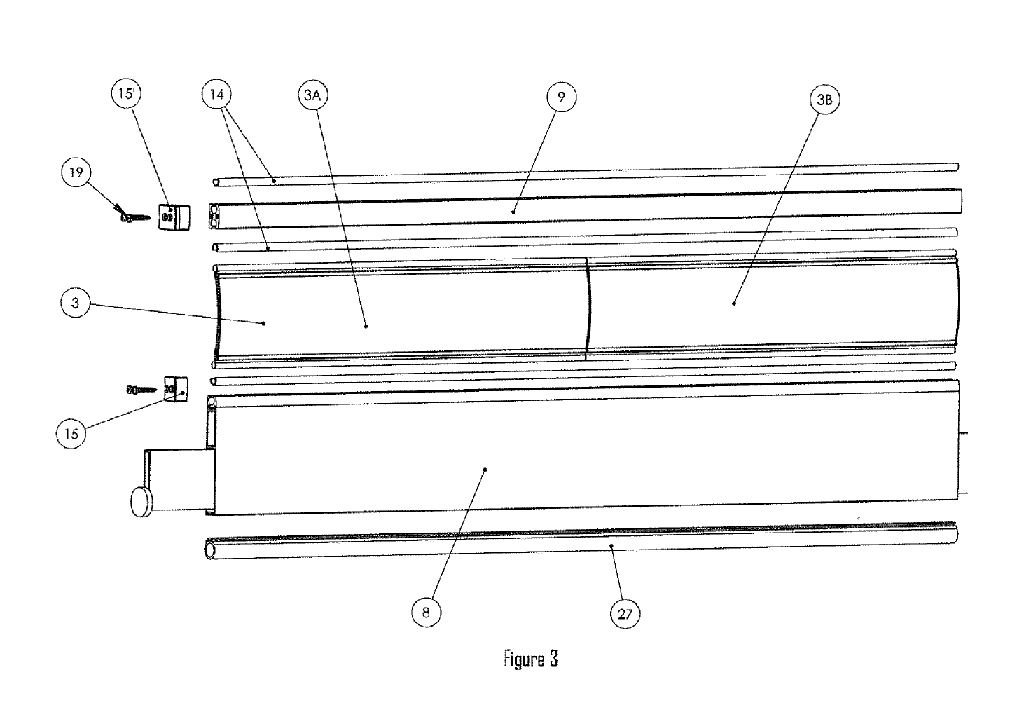

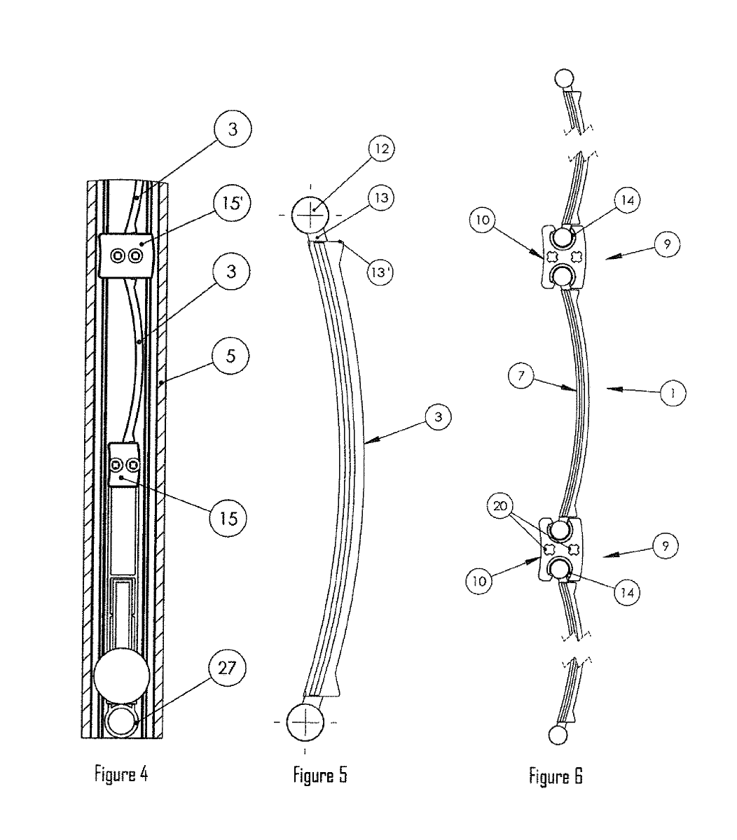

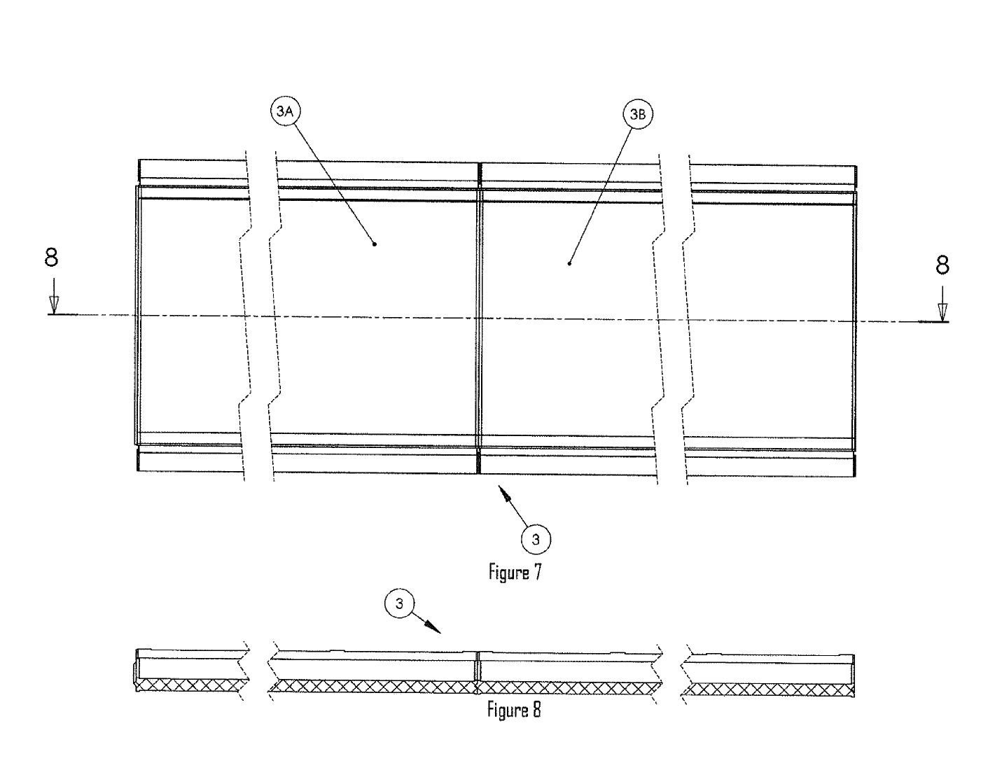

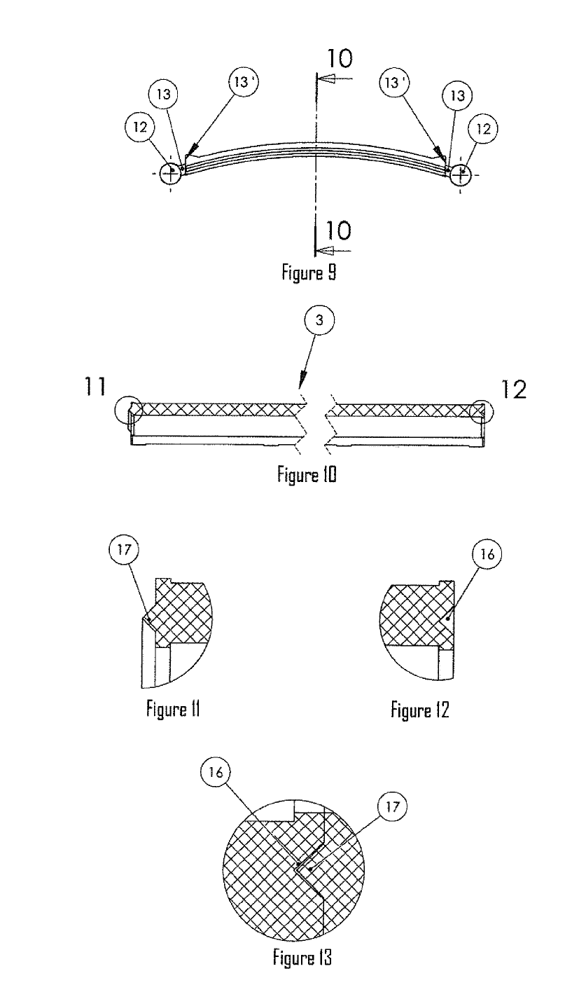

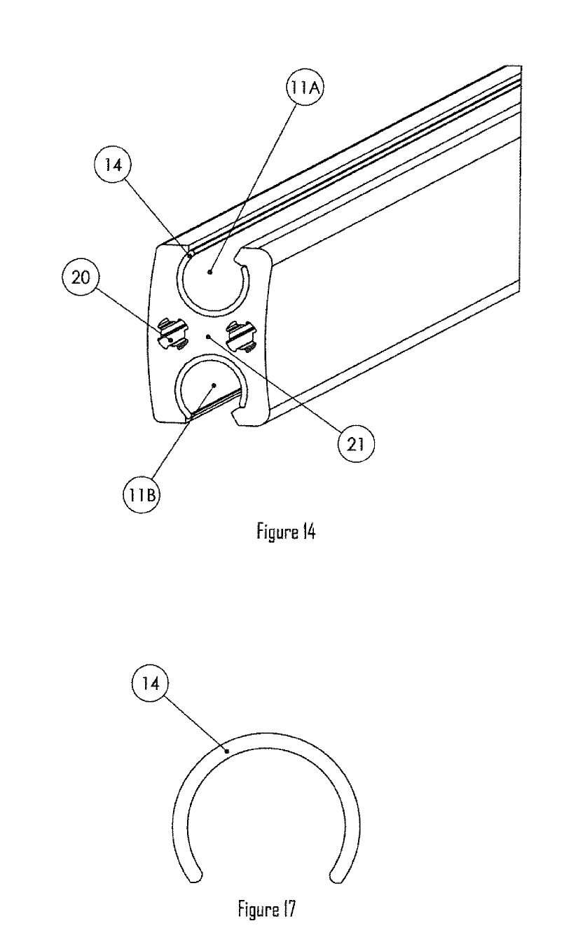

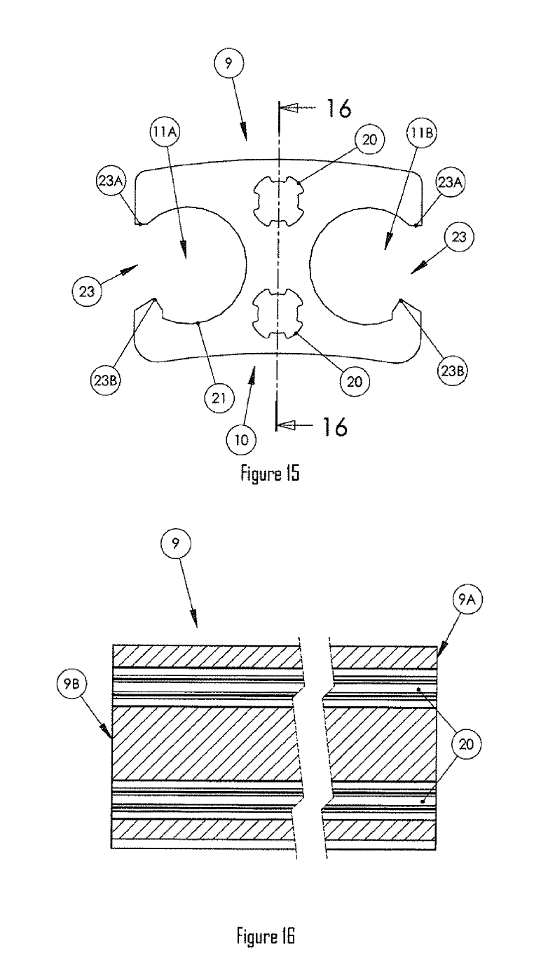

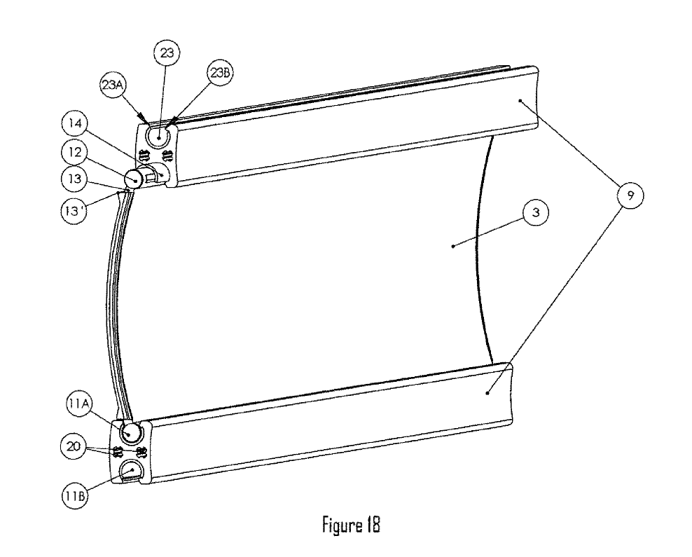

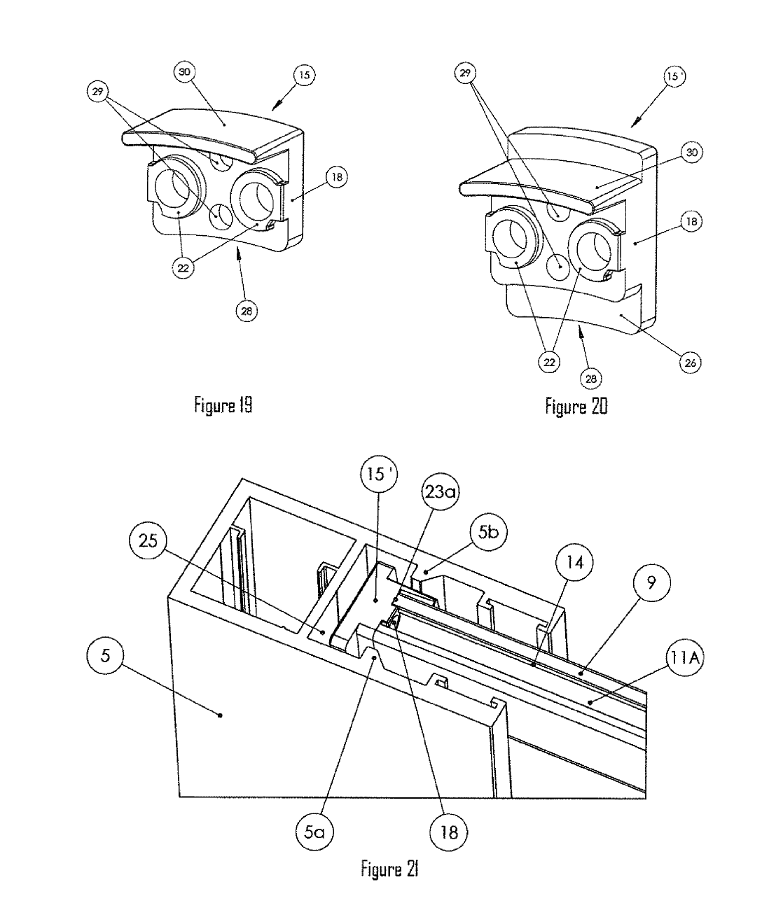

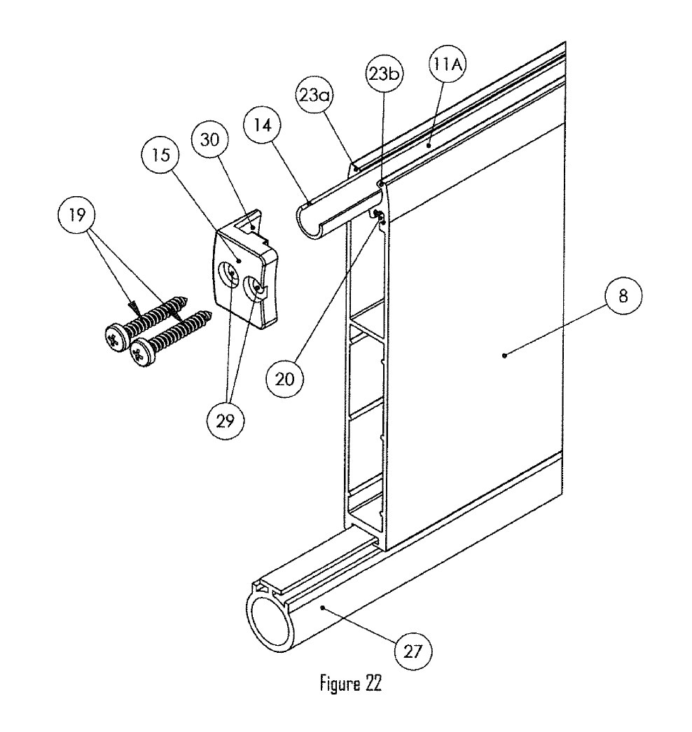

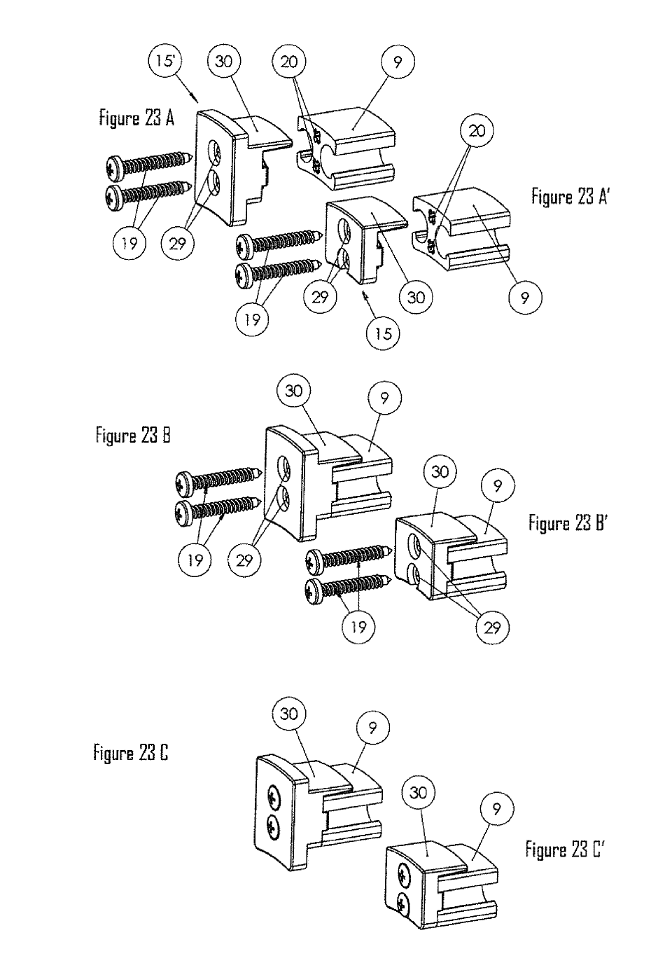

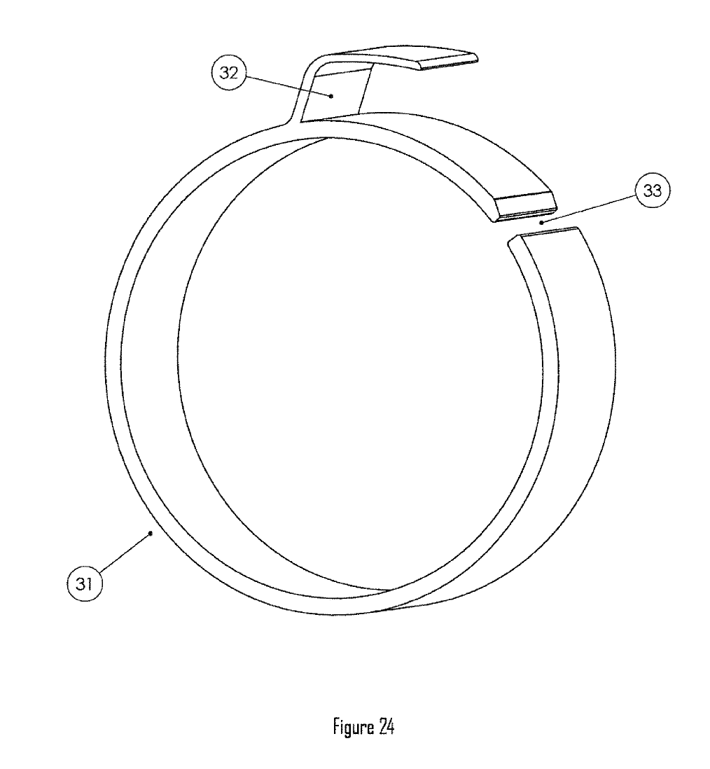

Reference to said drawings is being made to describe interesting, although not limiting, examples of implementation of the transparent roll-up curtain according to the invention.

### DETAILED DESCRIPTION OF THE INVENTION

The transparent roll-up curtain 1 to which the invention applies is of the type consisting of a roll-up curtain 2, comprising a number of transparent horizontal slats 3 that are articulated among themselves by means of articulation devices 9. This curtain is rolled up around a horizontal shaft or drum positioned above said apron. The opposite vertical edges of this apron move in lateral guides or slides 5.

The roll-up shaft or drum 4 is housed in a casing 6 positioned above the apron. Neither this casing nor the rotational drive of the roll-up shaft or drum are described here, as such devices, motorized or not, are well known by the expert and do not enter into the scope of the present invention.

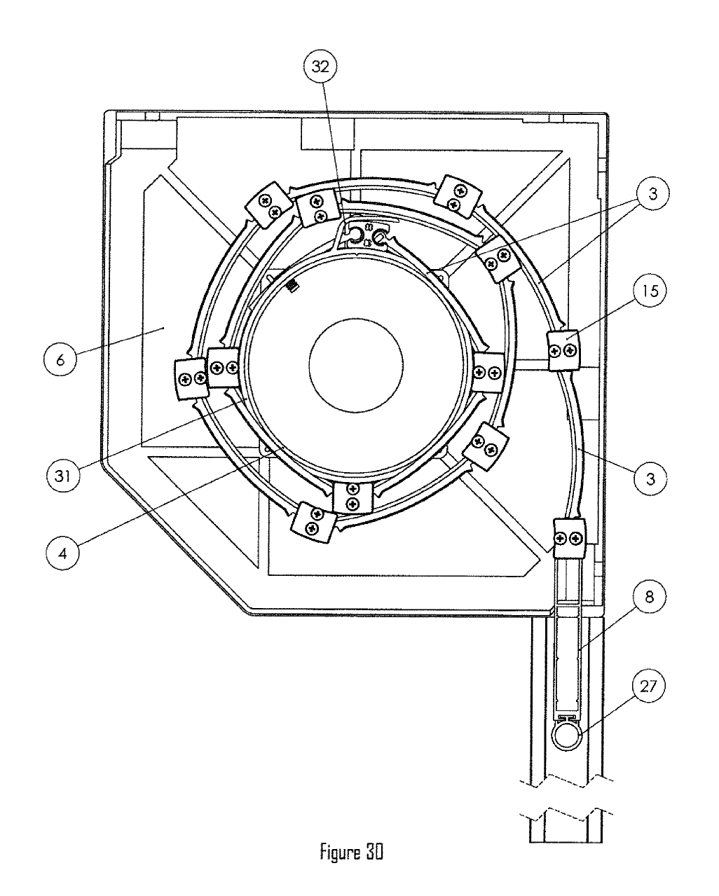

According to a first characteristic of the invention, each of said slats presents a transverse profile of shaped or curved form the concavity 7 of which is turned towards the roll-up shaft or drum 4, when the apron 2 is rolled up around the roll-up shaft or drum (FIG. 30).

The opposite longitudinal edges of the slats 3 are provided with assembly and articulation rods 12 with a circular section. These rods with circular section are connected to the respective longitudinal edges of the plates through the intermediary of a small bar 13 of small height. These rods 12 and the joining bars 13 which constitute the upper and lower rims of the slats, are made as a single piece with the slats 3 or the modules 3A, 3B, 3C composing these slats, during the manufacturing process by injection of said slats and/or modules.

The lower part 1A of the apron 2 is constituted by a slat 8 that is different from the others, the so-called ‘final’ slat, which may present a flat transverse profile and a greater height than the slates 3. As shown in FIG. 22, the lower edge of the final slat is provided with a bulge 27 made of a material with elastic deformability, for example rubber or a synthetic elastomer. This bulge 27 is intended to absorb the shocks as the curtain descends and/or to ensure impermeability while the curtain is in the lowered position.

The slats 3 may be made of any material presenting the desirable rigidity, solidity and transparency. They may for example be of polycarbonate produced by an appropriate injection process known by the expert. Advantageously, they may be of polycarbonate that is sold under brand names like “Lexan” or “Makrolon” which, apart from remarkable optic quality, offer good rigidity and mechanical resistance. Anti-UV treatment may be applied in a manner known as such, through incorporation in the basic material of the plates prior to the injection process. This treatment permits dispensing with the application of an anti-UV varnish after producing the plates, as is usually the case.

The slats 3 may present a relatively significant height, for example in the order of 85 mm, considerably above that of traditional transparent roll-up shutter slats. They may have a thickness in the order of 4 mm which gives them great solidity while permitting them a certain degree of flexibility and a shape memory thanks to which the transparent roll-up curtain according to the invention presents good resistance to shocks and attempts to tamper with them. Said slats may be coated with a varnish for optimal resistance to friction and scratches.

They may be endowed with excellent transparency or may be lightly tinged or not, or translucent, or opaque, or sparkled.

The slats 3 are constituted by several abutting modules or parts 3A, 3B, 3C . . . .

The bottom slat 8 may be made of aluminum using any convenient extrusion method.

The horizontal slats constituted by several modules or slat parts 3A, 3B, 3C . . . , may be longer than 6 meters, and make it possible to produce roll-up curtains of essentially identical lengths.

According to another characteristic of the invention, the slats 3 are interconnected by means of a joint and articulation section 9. Preferably, these joint sections are made of a material presenting the desirable rigidity and sturdiness, for example of extruded aluminum.

These sections 9 present a transverse profile that is approximately rectangular and slightly curved or arched, the concavity 10 of which is turned towards the roll-up shaft or drum when said apron 2 is rolled up on said shaft or drum (FIG. 30).

These joint sections 9 are executed in one piece, their length corresponding to the length of the slats consisting of several abutting modules. They feature two opposing longitudinal grooves 11A and 11B, extending along their edges, over their entire length. These grooves 11A and 11B have a generally circular profile and are open towards the outside.

This opening, constituted by a longitudinal slot 23, presents a width less than the diameter of the rods or assembly bars 12 of the slats 3 so that said rods constituting the upper and lower edges of the slats can be introduced by sliding into the grooves 11A and/or 11B of the joint profiles 9 and then find themselves maintained in said grooves, with the ability to swivel, by the inward-directed lips 23A, 23B delimiting said slot 23.

During the pivoting movements of the slats 3 relative to the joint and articulation sections 9, the joint bar 13 abuts against one or the other of the edges 23A and 23B of the slot 23 which limits the amplitude of the swivel of said slats.

On the other hand, along these upper and lower longitudinal edges, the slats 3 or the slat parts 3A, 3B, 3C . . . , to be precise, present a projection 13′ that protrudes on the convex surface of said slats 3 or slat parts 3A, 3B, 3C, these longitudinal projections 13′ thus constitute stops limiting the swivel of the latter relative to the joint sections 9.

Advantageously and preferably, a soundproofing joint 14 in the shape of a C, for example made of polyvinyl chloride (PVC) is housed in the grooves 11A and 11B. This interposed joint between the groove 23 and the bar 12 ensures a perfectly silent operation during the roll-up and roll-down operations of the rollup curtain.

According to another characteristic disposition, of the invention, the abutted modules or slat parts 3A, 3B, 3C . . . are assembled by jointing.

Preferably, the opposing abutment ends of the modules are provided, respectively, with a groove 16 and a rib 17 extending over the entire height of said abutment ends. Preferably, the groove 16 and the rib 17 present a triangular profile. More precisely, the groove 16 has a V-shaped profile, whereas the rib 17 has a beveled profile that imbricates itself exactly in said groove.

In this way, when the adjoining ends of two modules 3A, 3B, 3C, . . . are abutted, the ribs 17 find themselves exactly fitted into the grooves 16.

The slats 3 are kept in the joint and articulation sections through the intermediary of blocking caps 15 preventing any lateral sliding of said slats relative to said sections.

According to a characteristic disposition of the invention, these blocking caps 15 comprise an obturating body 18 applied on the ends 9A and 9B of the joint sections 9 so as to close off the entrance to the articulation grooves 11A and 11B made in said joint sections. This body is fastened against the end 9A or 9B of the joint sections 9, by at least one screw 19 and, preferably, by two self-tapping screws penetrating into the holes 29 present in said cap and in the cavities 20 made in the partition 21 separating said grooves 11A or 11B, parallel to the latter. These blocking caps present an approximately rectangular transverse and slightly curved profile the concavity 28 of which is turned towards the drive shaft or drum 4 when the apron 2 is coiled around said roll-up shaft or drum.

According to a preferred implementation, the inside face of the blocking caps presents points of excessive thickness or humps 22 engaged in the entrance of the articulation grooves 11A and 11B of the joint sections 9. These humps 22 of a generally cylindrical shape are shaped and dimensioned so they can be fitted without any noticeable play in said entrances. They serve to keep the blocking caps 15 in place on the ends of the joint sections 9 before the latter are fastened by means of self-tapping screws 19.

Preferably, the blocking caps present an upper rib or cap 30 constituting a support of the transparent shutter during the superposition of the coils so as to prevent the slats from rubbing against each other while the curtain is being rolled up and thus [prevent] the deterioration of the latter through the appearance of unsightly scratches on the transparent slats which would affect the visibility through said shutter and which would lead to fragility of said roll-up shutter.

The blocking caps 15 are, for example, made of PVC or any other suitable material.

The upper part 1B of the apron 2 is constituted by a first slat 34, analog to slats 3. The upper edge of the first slat is provided with at least one, and preferably several fastening plates 35 presenting a hole 36 for a fastening screw 37.

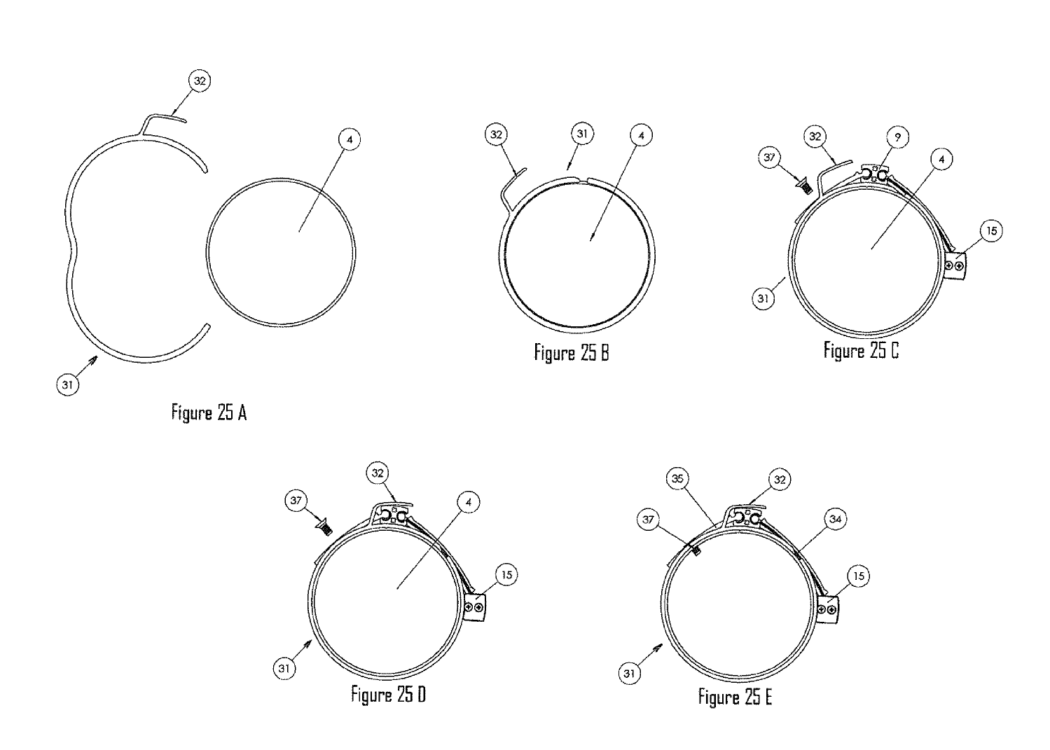

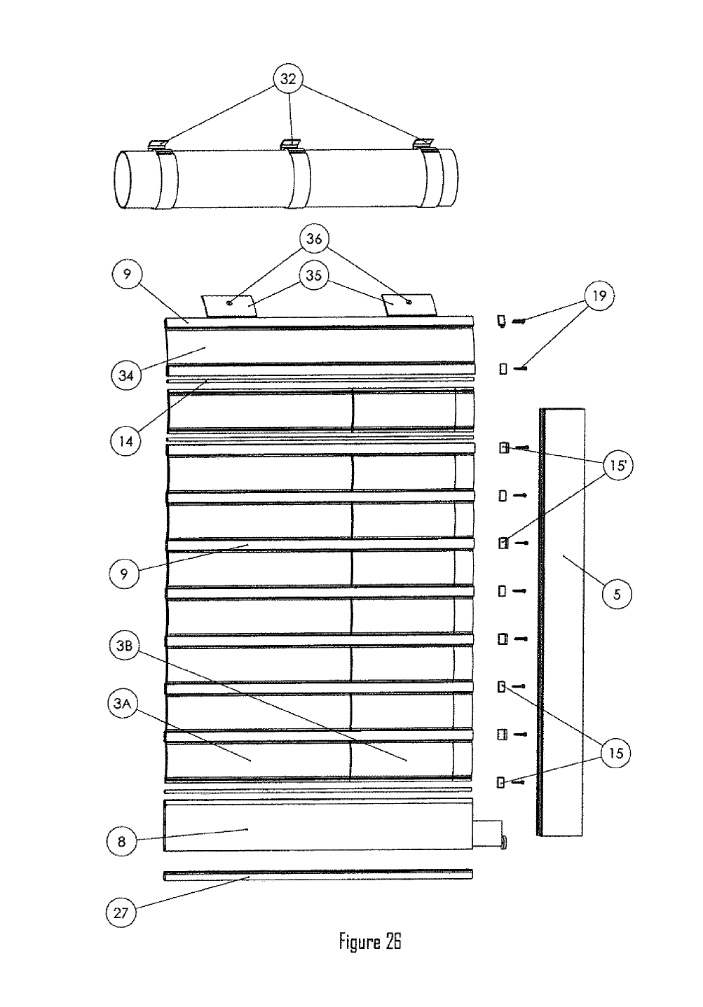

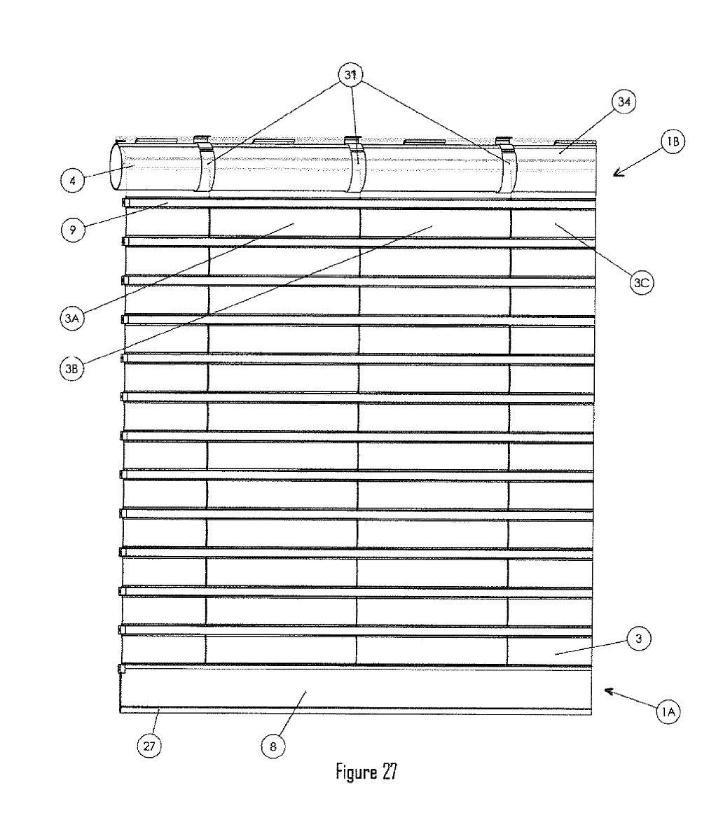

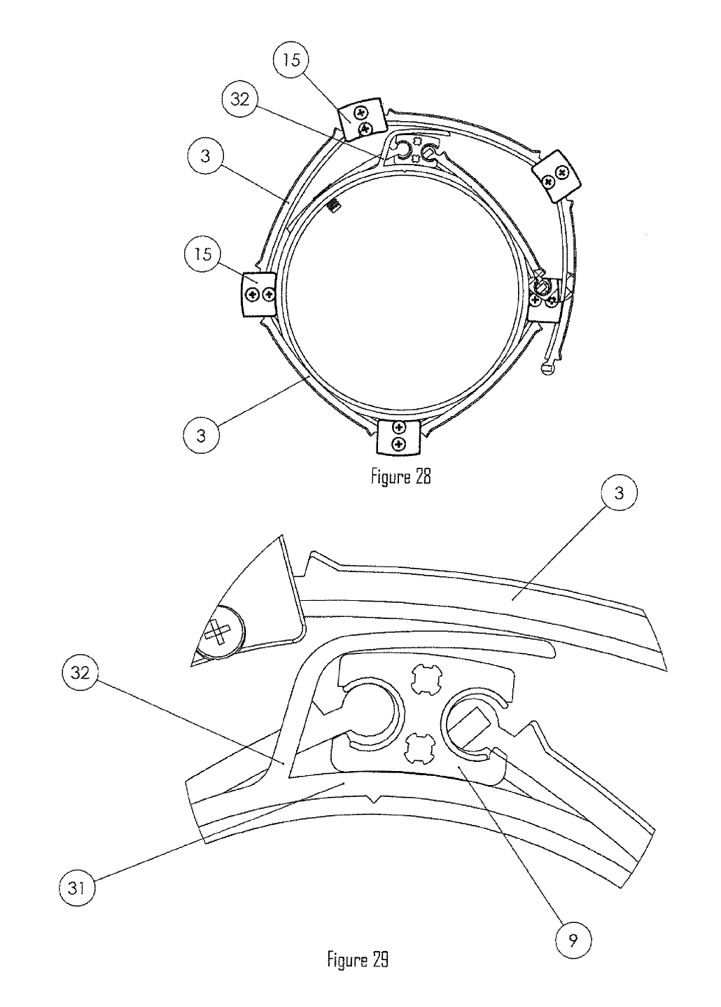

Advantageously the roll-up curtain according to the invention also features a ring 31, intended to be placed on the roll-up shaft 4. This ring consists of a ring of the same diameter, or approximately identical to that of the roll-up shaft or drum 4, comprising a slit 33 which permits its opening and deformation by spreading the edges of said slit (FIG. 25A).

This ring is also provided with a fin 32 surmounting a portion of the ring 31 and positioned at a distance from the outside face of said ring, so that during the installation of the curtain, the ribs (32) of the rings (31) cover the first joint section (9) in order to prevent the slats from rubbing on each other while the curtain is being rolled up and thus [prevent] the deterioration of the latter by the appearance of unsightly scratches on the transparent slats which would affect the visibility through said shutter and which would lead to fragility of said roll-up shutter.

Preferably, several rings 31 are placed on the roll-up shaft 4 so that they coincide with the intersection between two adjacent modules 3A, 3B, 3C.

Thus, during the fastening of the apron 2 of the roll-up shutter on the horizontal roll-up shaft or drum 4 (FIGS. 25A to 25E) the ring ends are spread so as to place them around the roll-up drum and the rings are pivoted around the drum axle 4 so that the fin 32 of each ring 31 covers the first section 9, the curtain is then fastened on the roll-up drum by turning screw 37 in the hole 36 of the fastening plates 35 on both sides of said rings 31. This screwing action results in the blocking of the rings 31 on the drum 4.

These roll-up rings are for example made of PVC or any other suitable elastic material permitting their deformation by spreading at the time of their placement on the roll-up shaft or drum 4 and the automatic return to their circular shape once they are positioned around said roll-up shaft.

The lateral ends of the aprons created according to the invention and featuring the afore-mentioned characteristics are mounted with an ability to slide in the vertical guiding slides 5 or gliding channels constituted by sturdy sections made for example of extruded aluminum or of steel in the manner known as such.

The vertical guiding slides have a general U-shaped profile the open side of which defines a longitudinal opening 24 extending over the entire height of said guiding slides. A vertical guiding channel 25 is made between the inward-directed front 5a and rear 5b wings of the slides 5, and the ends of the slats 3 and 8 and the sections 9 move inside said vertical channel.

The entrance to the vertical channels 25 in which the ends of slats 3 and 8 and of the joint sections 9 are moving is delimited by inward-directed wings extending over the entire height of the guiding slides 5 and, according to another characteristic disposition, at least certain blocking caps are shaped so they resist any stripping force resulting, for example, from very strong winds or attempts at burglary. For example, these blocking caps 15′ are equipped with lateral wings or overlapping parts 26, of greater width than the width of the entrance to the guiding channel. In the event of forces trying to unhinge the apron, the overlapping parts of the caps 15′ will hit against the inward-directed opposing wings 5a and 5b delimiting the vertical opening to the entrance of the guiding channels. This device prevents the slats from being ripped off when weather conditions are very severe, by ensuring better retention of the apron within the guiding slides.

1. Transparent roll-up curtain of the type featuring a roll-up apron around a horizontal shaft or drum placed above said apron, comprising a plurality of transparent horizontal slats articulated between themselves by means of articulation devices, the opposing vertical edges of said articulated apron moving in lateral guides or slides, characterized in that each of said slats presents a transverse profile of a curved shape the concavity of which is turned towards the roll-up shaft or drum when the apron is rolled up on said shaft or drum, and in that each slat of the plurality of horizontal slats is constituted by two or more than two modules or abutted parts of slats and assembled by fitting their ends together.

2. Transparent roll-up curtain according to claim 1, characterized in that the abutting ends of said modules are equipped respectively with a groove and a rib extending over the entire height of said abutment endings of the modules.

3. Transparent roll-up curtain according to claim 2, characterized in that the groove and the rib present a complementary triangular profile.

4. Transparent roll-up curtain according to claim 1, characterized in that the opposing longitudinal edges of the slats are equipped with assembly and articulation rings, with a circular section, connected to said longitudinal edges through the intermediary of a small bar of low height, and in that said slats are assembled through joint and articulation sections the edges of which are equipped with open longitudinal grooves extending all along said sections, namely an upper groove and a lower groove with a circular profile, in which are seated and maintained the bars with circular profile of two adjacent slats introduced by sliding into said grooves, these joint and articulation sections presenting a curved transverse profile the concavity of which is turned towards the roll-up shaft or drum when said apron is rolled up around said shaft or drum.

5. Transparent roll-up curtain according to claim 4, characterized in that the longitudinal grooves of the joint sections present inward-directed edges delimiting the opening of said grooves.

6. Transparent roll-up curtain according to claim 5, characterized in that a C-shaped soundproofing seal is housed in the grooves.

7. Transparent roll-up curtain according to claim 1, characterized in that said slats of the transparent rollup curtain are made of polycarbonate by an injection process.

8. Transparent roll-up curtain according to claim 7, characterized in that said slats of the transparent rollup curtain are made of polycarbonate of the ‘Lexan’ or ‘Makrolon’ type (registered trademarks).

9. Transparent roll-up curtain according to claim 1, characterized in that the joint and articulation sections are made of extruded aluminum.

10. Transparent roll-up curtain according to claim 1, characterized in that a final slat presents a flat transverse profile and a height greater than that of the slats, said final slat being made of aluminum.

11. Transparent roll-up curtain according to claim 1, in which the slats are maintained in the joint and articulation sections through the intermediary of blocking caps, characterized in that the blocking caps comprise an obturating body applied against the ends of the joint section so as to obturate the entrance of the articulation grooves made in said joint section, said body is fastened against the end of the joint sections, by screwing at least one screw and, preferably, two self-drilling screws penetrating, on the one hand, into the holes present on the blocking cap and, on the other hand, into cavities made in the partition separating said grooves parallel to the latter.

12. Transparent roll-up curtain according to claim 11, characterized in that the inside face of the blocking caps presents places of excessive thickness engaged in the entrance of the articulation grooves, and enabling said caps to be maintained against the ends of the joint sections before said caps are fastened by screws.

13. Transparent roll-up curtain according to claim 11, characterized in that the blocking caps present an upper fin or cap.

14. Transparent roll-up curtain according to claim 1, according to which the entrance of the vertical channels in which the ends of slats move and of the joint sections is delimited by inward-directed wings extending over the entire height of the guiding slides and in that at least certain blocking caps are shaped so as to resist any pullout force resulting, for example, from very strong winds or attempts of burglary, these blocking caps are provided with lateral wings or overlapping parts, of greater width than the width of the entrance of the guiding channel so that in the event of forces trying to unhinge the apron, the overlapping portions of the caps will hit against the inward-directed opposing wings delimiting the vertical opening to the entrance of the guiding channels.

15. Transparent roll-up curtain according to claim 1, characterized in that it features at least one ring and preferably, a plurality of rings to be positioned on the rollup shaft and comprising a fin surmounting a portion of the ring and positioned away from the outside face of said ring, so that during the installation of the curtain, the fins of the rings cover the first joint section in order to prevent the slats from rubbing on each other while the curtain is being rolled up and thus prevent the deterioration of the latter by the appearance of unsightly scratches on the transparent slats which would affect the visibility through said shutter and which would lead to fragility of said roll-up shutter.
